(19) United States
(12) Patent Application Publication
(10) Pub. No.: US 2007/0149214 A1
(43) Pub. Date: Jun. 28, 2007

(54) SYSTEM, APPARATUS, AND METHODS FOR LOCATION MANAGED MESSAGE PROCESSING

(75) Inventors: Joseph M. WALSH, Alexandria, VA (US); Richard P. BIBY, Waterford, VA (US)

Correspondence Address: NIXON & VANDERHYE, PC, 901 NORTH GLEBE ROAD, 11TH FLOOR, ARLINGTON, VA, 22203, US

(73) Assignee: SquareLoop, Inc., Reston, VA (US)

(21) Appl. No.: 11/610,078

(22) Filed: Dec. 13, 2006

Related U.S. Application Data
(60) Provisional application No. 60/749,598, filed on Dec. 13, 2005.

(51) Int. Cl. H04Q 7/20

(52) U.S. Cl. 455/456.1; 455/466

(57) ABSTRACT

Location-based messaging in which a location-aware device receives a transmitted message and processes at least a portion of the message content using at least one criterion that is based on the device's location.

### CROSS-REFERENCES TO RELATED APPLICATIONS

This application claims the benefit of Provisional Application No. 60/749,598 filed 13 Dec. 2005, the contents of which are incorporated herein by reference.

### TECHNICAL FIELD

The subject matter herein relates to location based messaging and services, and more particularly to providing privacy-enhanced and network optimized location-based services to mobile device subscribers and other users. The subject matter herein has applications in the fields of computer science, electronics, wireless communications networks, and marketing.

### BACKGROUND AND SUMMARY

Some of the most effective and useful messages we receive are location based. A shopkeeper who posts a message on his door saying “Be Back in 5 Minutes” is using a very effective form of location-based messaging. The only people who see the message are the ones who need to see it (those standing at the door to the shop), and the message is very relevant to those people (the message tells them they must wait five minutes or less before the shop door is once again opened). Other examples of useful location-based messages include “for sale” signs posted in front of houses, flyers handed out in front of a store, and proximity-based audio broadcasts in museums, to name a few.

An interesting challenge is to efficiently deliver location-based messaging to the now-ubiquitous cellular telephone and other wireless messaging devices that many people carry with them. Some work has been done in the past, but further developments are desirable.

For example, some types of more traditional location-based messaging may forfeit the location privacy of the handset by requiring the handset to report its location. This capability is central to advertised “trail of breadcrumbs” location tracking provided by mobile device location tracking services. @Road and other vendors provide these services using a variety of technologies, including cellular and satellite communications.

However, it would be desirable in certain contexts to operate on an anonymous basis by broadcasting messages and letting the mobile device independently determine which messages should be displayed. The technology herein addresses these and other needs.

The exemplary illustrative non-limiting implementations herein provide devices, methods, and systems for providing location-based messaging. More specifically, exemplary devices, methods, and systems provide, in some embodiments, location-based messaging in which a location-aware device receives a transmitted message and processes at least a portion of the message content using at least one criterion that is based on the device's location.

For example, exemplary illustrative non-limiting implementations provide devices for processing transmitted messages received by the device. In some exemplary illustrative non-limiting arrangements, the devices comprise a signal receiver configured to receive a transmitted message including message content; a device locator coupled with the receiver that is configured to provide an estimated geographical position of said telecommunications device; a mechanism for determining a least one historical geographical location of the device, at least one future location of the device, or both historical and future locations of the device; and a message content filter that is configured to determine whether at least a portion of the received message content complies with at least one geographical position criterion.

In these specific exemplary illustrative non-limiting implementations, a geographical position criterion is based on information provided by the mechanism for determining at least one historical position. In further exemplary illustrative non-limiting implementations, the mechanism for determining at least one historical position is configured to provide a record of past geographical locations of the telecommunications device. And in yet further exemplary illustrative non-limiting implementations, the geographical position criterion includes a geographical position criterion based on the record of past geographical locations of said telecommunications device.

In other exemplary implementations, the geographical position criterion includes a geographical position criterion based on information provided by said mechanism for determining at least one future geographical location. In more specific examples of such implementations, the geographical position criterion based on an estimated future location of said telecommunications device. In yet more specific examples of such devices, the estimated future location is based on an historical record of geographical positions of said telecommunications device.

In another aspect, the exemplary illustrative non-limiting implementation provides methods for receiving and processing messages transmitted to a telecommunications device. In some implementations, the methods comprise providing a telecommunications device that includes: a signal receiver configured to receive a transmitted message including message content; a device locator coupled with the receiver that is configured to provide an estimated geographical position of said telecommunications device; a mechanism for determining at least one historical geographical location of the device, at least one future location of the device, or both at least one historical geographical location of the device and at least one future location of the device; and a message content filter configured to determine whether at least a portion of the message content complies with at least one geographical position criterion receiving a transmitted message using said telecommunications device. The methods further include: determining the geographical location of the telecommunications device; providing the device's geographical location and at least a portion of the message content to the message content filter; and applying at least one geographical position display criterion to the message content.

Other exemplary illustrative non-limiting systems embed the coordinates of the target location into the message and broadcast the message to a subscriber or other user a subset of subscribers or other users. or all subscribers or other users. One or more mobile device applications on the subscriber or other user's mobile device intercept the message and display the message if the mobile device applications determine the mobile device is within the target message area.

Still other exemplary illustrative non-limiting systems allow system users to send geographically targeted messages to mobile devices while optionally maintaining anonymity of the device's location. There are many applications for the technology herein including for example location-based alerts, content delivery, and mobile marketing to name a few.

One exemplary illustrative implementation envisioned for the system is called the Mobile Alert Network (MAN). Mobile Alert Network provides location-based messaging to subscribers or other users based upon their current, past, and future predicted locations. However, many messages do not make sense or are useless if the subscriber or other user is not in the right location for the message to be meaningful. For example, information about a traffic accident in Virginia is useless if a subscriber or other user is in California, while an emergency evacuation notification for a subscriber or other user's home area is likely to be relevant to the subscriber or other user wherever they currently are.

In an exemplary application of the devices, methods and systems provided by the exemplary illustrative non-limiting implementation, emergency managers can use the MAN to deliver geographically targeted messages, such as evacuation instructions to subscribers or other users downwind of a chemical explosion, while sending “shelter-in-place” messages to subscribers or other users upwind. In this example, a message transaction for an event in Roslyn, Va. (an area in Arlington County, Va.) may have a critical message for people within Roslyn and a separate warning message for people within Arlington County. A subscriber or other user within Roslyn will receive only the critical message. A subscriber or other user in Arlington County will receive the warning message. However, if the latter subscriber or other user then traveled into (or was projected to travel into) Roslyn during the valid time period for the message, they will then receive the critical message.

Similarly, law enforcement may broadcast a targeted appeal for assistance to those subscribers or other users who are in the vicinity of an event. The targeted appeal for assistance will be displayed for those subscribers or other users who are in the targeted geographic area at a specified time. Similarly, the system may provide a mobile version of the “Amber alert” system, along with such features as “push to talk” to connect the subscriber or other user with authorities.

A feature of an alerting application provided by the exemplary illustrative non-limiting implementation is the use of mobile device location information along with information collected by the mobile device in the past to estimate where the mobile device is likely to be in the future. For example, if a subscriber or other user normally drives from the Capital building in Washington D.C. to Fairfax Va. each evening between 3:30 and 4:30 p.m., generally following Interstate 66, the predictive alerting application identifies that the subscriber or other user will be crossing the Washington D.C. beltway at approximately 4:15 p.m. If an accident occurs at the junction of the Beltway and 1-66 at 4:00 p.m., the subscriber or other user is alerted because they are predicted to be within the area of effect of the accident, while if the accident occurs at 1:00 p.m., the subscriber or other user would not be alerted. Predictions may be made based upon either current travel (the subscriber or other user is driving now, either to a known location along a known route, or in a general direction), or upon expected travel (the subscriber or other user drives home each day from approximately 6:00-7:00 p.m.). FIG. 1 illustrates one exemplary illustrative non-limiting data structure including the nested alert levels of the above example.

Messaging as a means of delivering mobile content is on the rise. Text messaging, such as SMS, and other mechanisms of providing content to mobile devices, are continually being developed. However, many types of content do not make sense or are useless if the subscriber or other user is not in the right location to use them.

A location-aware mobile device can request and receive content that becomes conditionally relevant based upon the current location of the device. Similarly, a mobile device can pre-cache potentially relevant content based upon predicted future locations of that device. For example, the mobile device can be aware that it is likely to travel during the afternoon. Information related to the expected travel can he opportunistically pre-fetched to the device. In order to optimize storage on the device, the pre-fetched information can be set to expire in a relatively short period of time. After expiration, the device will automatically purge information from its internal database that is no longer relevant.

For example, if a subscriber or other user is scheduled to meet someone at a specific Starbucks, information related to that Starbucks, including their address, phone number, driving directions, and WiFi connection information, is conditionally useful if it is on the mobile device at the time the subscriber or other user is in transit. The mobile device, using information about predicted travel (either derived from travel patterns or deduced from an information source such as a PIM), can opportunistically update its mobile cache of geographically relevant Starbucks (or competing coffee shops) locations, wireless interact access connection information, and other related materials. The opportunistic updating can take advantage of high-bandwidth connections as they are available so as to make this updating transparent to the subscriber or other user of the mobile device.

In simplest form, time and location-aware capability of the device may be used to pre-deliver content to a subscriber or other user, and release that content to the subscriber or other user at a specific date and time. In this manner, content may be pre-staged to a mobile device and conditionally delivered to the subscriber or other user based upon one or more constraints, such as location, time, or the presence (or absence) of other materials database records, or messages on the mobile device.

Alternatively, the location-aware capability of the device may be used in conjunction with applications servers to limit or refine search results. The location aware nature of the device supports location aware-searching, in which the search results are restricted based upon the location of the device. In one example, a mobile device subscriber or other user who searches for movie listings using their location aware mobile device will have the available listings sorted by distance from them, and listings for movie offerings that are not geographically relevant will be eliminated. Furthermore, listings for movies that it is not feasible to reach the theater before the movie starts can be eliminated from the available listings provided. This combination of location aware mobile device that uses its location (or projected location) to further screen, filter, or refine a general web-based search provides broad capabilities.

Marketers are looking for ways to capture consumers' attention. TiVo-type devices have minimized the amount of time consumers spend watching TV commercials, and software is minimizing the impact of Internet advertising. The mobile device is the next step (or 3rd screen) for marketing. Additionally, the mobile nature of the mobile device enables marketers to send messages near the point of action. For example, a marketer may send a coupon for free French fries over a WiFi network while a mobile device is near (or is projected to be near) a McDonalds at lunchtime.

Mobile advertising may also include contact information including web information, telephone numbers to call for additional information, text message/chat session information, or direct connect information to support the instant connection of the mobile subscriber or other user to a live operator. A subscriber or other user can have questions answered immediately, or can make a purchase decision and then execute the purchase with the assistance of a support staffer. In this scenario, a message is broadcast with location-aware information. The message optionally contains some mobile content and contact information.

Alternatively, a vendor may local-cast a message to all subscribers or other users at FedEx Field on a Sunday afternoon, which sets a location tag within the mobile device. At a later date, that vendor may broadcast an advertisement of interest to Redskins fans for all people who were at the Redskins game on that Sunday afternoon.

### BRIEF DESCRIPTION OF THE DRAWINGS

These and other exemplary non-limiting illustrative features and advantages will be better and more completely understood by referring to the following detailed description of exemplary illustrative non-limiting implementations in conjunction with the drawings.

FIG. 1 illustrates a data structure having nested information elements in accordance with one exemplary illustrative non-limiting implementation;

FIG. 2a illustrates an exemplary illustrative non-limiting method for comparing locations in which the overlap of two radii, one extending from a location and the other extending from a mobile device, are compared to determine whether the exemplary device and the location are the same;

FIG. 2b illustrates another exemplary illustrative non-limiting method for comparing locations in which position information from a set of transmitters is used to determine whether a location and a device are in the same location;

FIG. 3 is a block diagram of an exemplary illustrative non-limiting mobile device;

FIG. 4 illustrates an exemplary non-limiting illustrative process for converting a set of location records to a trip template;

FIG. 5 illustrates an exemplary illustrative non-limiting process for creating a trip template from a set of driving directions, and

FIG. 6 illustrates an exemplary illustrative non-limiting process for computing a projected time at locations based upon current location, a current time, and a trip template, and adjusting these calculations based upon external information

### DETAILED DESCRIPTION

Exemplary Illustrative Non-Limiting Systems for Location-Aware Messaging

Exemplary illustrative non-limiting implementations provide a system for location-aware communications. An exemplary illustrative non-limiting system architecture comprises one or more mobile devices, such as those described herein, and associated application software, a commercially or privately available wireless infrastructure, and at least one application server. The provision and implementation of the exemplary non-limiting elements can be accomplished by those having ordinary skill in the art using the exemplary descriptions and examples provided herein.

One exemplary illustrative non-limiting implementation provides a telecommunications system that comprises a transmitter configured to transmit messages to a telecommunications device for receiving and processing said messages. The telecommunications device may for example include:
a signal receiver configured to receive a transmitted message including message content;
a device locator configured to provide an estimated geographical position of the telecommunications device coupled with the receiver;
a mechanism for determining a least one historical geographical location of said device, at least one future location of said device, or both an historical geographical location and a future location of the device; and
a message content filter configured to determine whether at least a portion of the received message content complies with at least one geographical position criterion.

In still further implementations, the geographical position criterion includes a geographical position criterion based on information provided by said mechanism for determining at least one historical position. In other exemplary implementations, the geographical position criterion includes a geographical position criterion based on said estimated future location of said telecommunications device.

In exemplary illustrative non-limiting implementations in which the exemplary system includes wireless communications, the wireless infrastructure may be a commercial wireless network operated by a commercial mobile device carrier using either COMA and its extensions, or GMS/GPRS and its extensions and/or other protocols. An example of one such wireless infrastructure is the Sprint/Nextel wireless network operated within the United States. Alternatively, the wireless infrastructure may be a wireless Ethernet infrastructure such as those created using WiMax, 802.11g, wireless Ethernet or any other wireless approaches. Other alternative wireless infrastructure mechanisms such as Bluetooth or television or other signals may be utilized (for location services, for message delivery, or a combination of both).

The exemplary illustrative non-limiting telecommunications architecture provides for messages to be sent between at least one applications server and at least one mobile device over the wireless infrastructure, whereupon the message is received by the mobile device and processed by a mobile application resident thereupon. Processing can occur either immediately upon receipt or at a later time, or both. For example, the device can store the message, or a portion of the message content, for processing at a later time. An optional response message or query from the mobile device to the application server also may be sent from the device.

In some exemplary illustrative non-limiting implementations, the messages are sent using a point-to-point model (e.g., an SMS message). In other non-limiting implementations, the messages are sent using a broadcast model in which each mobile device is responsible for selecting those messages that are relevant to its applications. Messages can be sent using a combination of these models as well. In more specific exemplary illustrative non-limiting implementations, a focus is on the efficient movement of messages between application servers and mobile devices, which reduces network provider costs of providing bandwidth for large scale notifications. The broadcast mode further enhances the anonymity of the subscriber or other user as it does not reveal the location or address of the mobile device.

Each application server in exemplary illustrative non-limiting implementations provides one or more components for operating the server side of a location-based application. Examples of such applications include the provision of location-based alerting (e.g. emergency management notifications, incident alerting), content delivery, and mobile marketing applications described above.

In more particular examples, an exemplary telecommunications system comprises a transmitter configured to transmit messages to a telecommunications device capable of receiving and processing such messages. The telecommunications device includes:
a signal receiver configured to receive a transmitted message including message content;
a device locator coupled with the receiver configured to provide an estimated geographical position of the telecommunications device;
a mechanism for determining a least one historical geographical location of the device, at least one future location of the device, or both; and
a message content filter configured to determine whether at least a portion of the message content complies with at least one geographical position criterion.

The elements of such systems and devices are now described in greater detail.

Exemplary Illustrative Non-Limiting Devices for Location-Aware Messaging

An exemplary illustrative non-limiting implementation provides telecommunications devices for receiving and processing messages transmitted to such telecommunications devices. In some exemplary arrangements, the devices comprise a signal receiver configured to receive a transmitted message that includes message content. The exemplary device includes a device locator coupled to the receiver. The device locator is configured to provide an estimated geographical position of said telecommunications device as described hereinbelow. A mechanism for determining a least one historical geographical location of said device, at least one future location of said device, or both historical and future locations of the devices is also included. More specific details of such exemplary illustrative non-limiting mechanisms are described below. The exemplary illustrative non-limiting device also includes a message content filter that is configured to determine whether at least a portion of the received message content complies with at least one geographical position criterion.

In a more specific exemplary illustrative non-limiting arrangement, the geographical position criterion includes a geographical position criterion based on information provided by the mechanism for determining at least one historical position. In a still more specific exemplary illustrative non-limiting arrangement, the mechanism for determining at least one historical position is configured to provide a record of past geographical locations of said telecommunications device. In a still more specific implementation, the geographical position criterion includes a geographical position criterion based on said record of past geographical locations of said telecommunications device.

In other exemplary illustrative non-limiting implementations, the mechanism for determining at least one historical position is configured to provide an estimated historical location of the telecommunications device. In more specific exemplary implementations, the one geographical position display criterion includes a geographical position display criterion based on an estimated historical location of said telecommunications device.

In still other implementations, the one geographical position criterion includes a geographical position criterion based on information provided by the mechanism for determining at least one future geographical location. In more specific exemplary illustrative non-limiting implementations, the geographical position criterion includes a geographical position criterion based on an estimated future location of said telecommunications device. In still more specific implementations, the future position determination mechanism is configured to estimate a future location of said telecommunications device based on an historical record of geographical positions of said telecommunications device.

In some exemplary illustrative non-limiting implementations, the exemplary illustrative non-limiting implementation provides a telecommunications device for receiving and processing messages transmitted to such a device that comprises:
a signal receiver configured to receive a transmitted message including message content;
a device locator coupled with said receiver configured to provide an estimated geographical position of said telecommunications device;
a message store; and
a message content filter configured to determine whether at least a portion of the message content complies with at least one geographical position criterion.

In some exemplary illustrative non-limiting implementations, the device further comprises an historical position determination mechanism coupled with the message content filter. In more specific implementations, the one geographical position criterion includes a geographical position criterion based on information provided by the historical position determination mechanism. Alternative exemplary arrangements include those for which the historical position determination mechanism is configured to provide a record of past geographical locations of the telecommunications device. More specific exemplary illustrative non-limiting implementations of such alternatives include those in which the geographical position criterion includes a geographical position criterion based on a record of past geographical locations of the telecommunications device. Still other alternative implementations include those for which the historical position determination mechanism is configured to provide an estimated historical location of the telecommunications device. More specific implementations of these alternatives include those for which the geographical position criterion includes a geographical position criterion based on an estimated historical location of said telecommunications device.

In still other exemplary implementations, the device further comprises a future position determination mechanism coupled with the message content filter. More specific implementations include those for which the geographical position criterion includes a geographical position criterion based on information provided by the future position determination mechanism. Still more specific exemplary non-limiting implementations are those for which the geographical position criterion includes a geographical position criterion based on said estimated future location of the telecommunications device. Yet more specific implementations are those for which the future position determination mechanism is configured to estimate a future location of the telecommunications device based on an historical record of geographical positions of said telecommunications device.

In some exemplary illustrative non-limiting implementations, the mobile device is a wireless mobile device such as a mobile telephone; but the device may be any transmitter, receiver and/or transceiver that is able to send and/or receive messages using at least one component of the infrastructure and operate the desired mobile applications. In some exemplary illustrative non-limiting implementations, the infrastructure is based on wireless communications and the device includes a wireless transceiver. In other exemplary non-limiting implementations, the mobile device has a global positioning system (“GPS”) component. In other exemplary illustrative non-limiting implementations, the device approximates the position determining functionality of a GPS using methods described below. In some exemplary illustrative non-limiting implementations, the infrastructure is based on wireless communications. Such devices and functions can be provided by those having ordinary skill in the art using the disclosure herein.

Exemplary Illustrative Non-Limiting Location Determination

In some exemplary illustrative non-limiting implementations, each mobile device includes a device locator that determines its location. Examples of suitable device locators include a GPS receiver or other mechanism that provides the device's geospatial location information. Other geospatial location mechanisms of this type might include “inertial” systems that compute a location based upon a known starting point and compute a current location based upon known direction and velocity.

In other exemplary illustrative non-limiting implementations the device locator is configured to determine the device's geospatial position at a coarser grain of accuracy by examining external inputs, such as the radio frequency spectrum, and noting those signal sources present on the external inputs and their signal strength. If the locations of the signal sources are known, an approximate location may be determined. If specialized characteristics of the signal are present (such as phase), additional calculations may be made to determine which of several locations is most probable. In some cases, a correlation of signal strength to distance from the signal source is possible, and the distance from the signal source may be computed based solely upon the signal strength. In other cases, a map that indicates relative signal strength expected from a specific source may be used to indicate the probable location(s) of the receiver based upon the strength of the received signal.

In one example, the mobile device monitors a radio frequency (“RF”) receiver and identifies the transmission source for which there is sufficient signal to identify a specific transmitter. By noting the signal strength of a single signal source, a location within a circular band may be presumed. If the signal from the signal source is phased in accordance with the radial angle from the signal source, the radial direction to/from the transmitter may be determined, and a geospatial coordinate along that radial axis may be determined.

In another example, if a plurality of transmission sources are observed, and a signal strength calculated from each transmission source, a mobile device can calculate its location to within a band around curve located between the transmission sources. If the mobile device is moving and multiple measurements are taken over time, the intersection between the computed bands may be calculated and a location of the mobile device calculated.

Similarly, the timing advance provided to a mobile device by a transmission source (or calculated by the device based upon information provided by a transmission source) and associated with a transmitted message may be used to determine an approximate distance from a transmission source. In this case, the timing advance describes the amount of time a mobile device may delay or advance the transmission of a message for the message to reach a transmitter during a desired timeslot. The timing advance is correlated to the speed of light, and may be used to calculate a distance from a transmitter.

In some cases, the RF frequency transmitter is a cellular telephone transmitter, with an antenna mounted at a well-known location, such as commonly deployed in GSM/GPRS systems. The location of cellular telephone towers is available in database form, and directories of transmission towers and the transmitters with antennas mounted upon them are readily available, although the delivery and update of relevant information to a mobile device remains problematic. Remote antennas from a single transmitter may be considered individual transmitters for the purposes of this discussion.

In other cases, alternative inputs are considered when determining the location of a mobile device. Alternative networks, such as the presence of a WiFi “hot spot” or a Bluetooth, provide both a received signal strength indication and an identification of the transmitter. These alternate sources also may be used to determine the approximate location of a mobile device. The IP address obtained from a DHCP service also may be used to assist with determining a location. In cases where wireless access points serve different IP ranges to connected mobile devices, the mobile device's IP address provides insight as to the wireless access point a mobile device is connected to. If the range of the wireless access point's signal is known, the mobile device may be positioned based in part upon that information.

Taken together, WiFi, Bluetooth, cellular, and any other type of transmitted signals may be used alternatively or together to determine the location of a mobile device. These signals, and their characteristics, may be used as a basis for location calculation, and further may be mapped against commonly available information that indicates the location of signal sources and expected signal strengths. Other inputs, such as those provided by interior Location systems such as Cricket, may add non-RF techniques to further refine the location of the mobile device within an interior space. Additional details and examples are described below.

Exemplary Illustrative Non-Limiting Location Matching

In some exemplary illustrative non-limiting implementations, the device locator is configured to determine whether two locations are identical. Different location sources provide locations of differing precision, and thus exact matching of location parameters rarely will be successful. Therefore, a set of location matching algorithms is required in order to successfully compare locations based upon different sources.

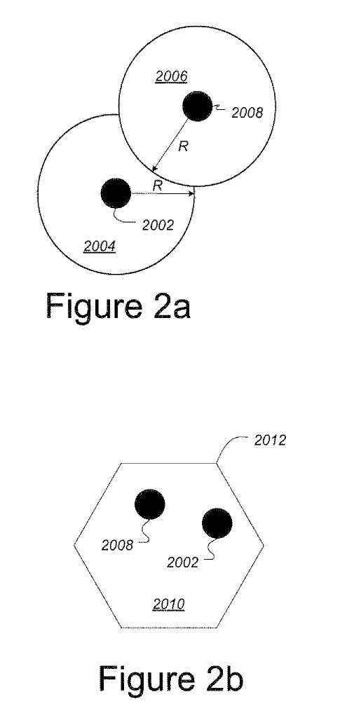

Locations may be matched in a number of ways. In a first instance, a mobile device's location is considered to “match” a specified location when the two locations' coordinates match exactly, or match to within a specified tolerance. For example, as illustrated in FIG. 2a, the two locations may be considered to match if the mobile device (2002) having some area (2004) of radius, R, intersects an area (2006) also defined by a radius, R, from the specified location's coordinates (2006). This type of location can be determined by GPS reading or taken from external mapping sources. Mechanisms for making such determinations can be implemented by those having ordinary skill in the art.

Alternatively, a location may be defined as an area surrounding a particular location or defined by one or more specific locations. For example, with reference to FIG. 2b, a location may be specified as a polygon (2010) with vertices (e.g., vertex 2012) defined by geographic coordinates. Device location (2002) is considered to match a specified location (2008) if the specified location's coordinates (or area specification) is determined to intersect the area of the polygon (2012). Algorithms for determining whether a second point or second polygon is contained within or intersects a first polygon are well understood in the computer graphics and graphics modeling disciplines. In a first instance, this type of location matching may be used for specifying message delivery areas, and then determining if a mobile device present within the message delivery area.

Exemplary Illustrative Non-Limiting Mobile Device

In some exemplary illustrative non-limiting implementations, the mobile device is a hardware and software system comprising hardware, operating system software, and application software. The hardware components of a mobile device comprise a processor, a display or video screen, memory (RAM. ROM. Flash), and an optional mass storage means such as a hard disk drive, all operably connected. In addition, the mobile device has at least one external input operably connected to the hardware system. The external input preferably comprises a wireless transceiver, such as those used by mobile telephony systems, wireless Ethernet systems, Bluetooth, or other systems. A preferable system is based upon at least one mobile telephony transceiver. More than one wireless transceiver may be integrated into the hardware system.

In more specific implementations, the mobile device provides an optional hardware location device, such as a GPS receiver or other hardware able to determine a location of the mobile device solely based upon external inputs as discussed above. Alternatively, the mobile device may include hardware that provides some of the inputs required for determining the location of the mobile device.

In some non-limiting arrangements, the mobile device's operating system software provides operating system services such as task and memory management to the mobile device, as well as hardware dependant drivers for interfacing to mobile device hardware. The mobile device operating system may be any of those well known in the art, including but not limited to: Symbian, Windows CE .NET, Embedded Linux, PalmOS, alternative mobile device versions of these operating systems, or other operating systems for mobile devices. In some cases, an embedded J2ME component may serve as a mobile device operating system. The mobile device operating system additionally comprises software “device driver” components that interface to mobile device location hardware, such as the optional GPS receiver described above. The device drivers provide a common interface to disparate mobile device hardware and abstract the specifics of mobile device hardware from applications software developers.

In other exemplary illustrative non-limiting implementations, the mobile device's application software comprises a configuration component, message management component a device update component, location calculation component, and at least one mobile device application component. In some more specific implementations, the application software is written using a commercially available system, such as J2ME, and is extensible to provide operators the ability to deploy their own applications and branding customizations.

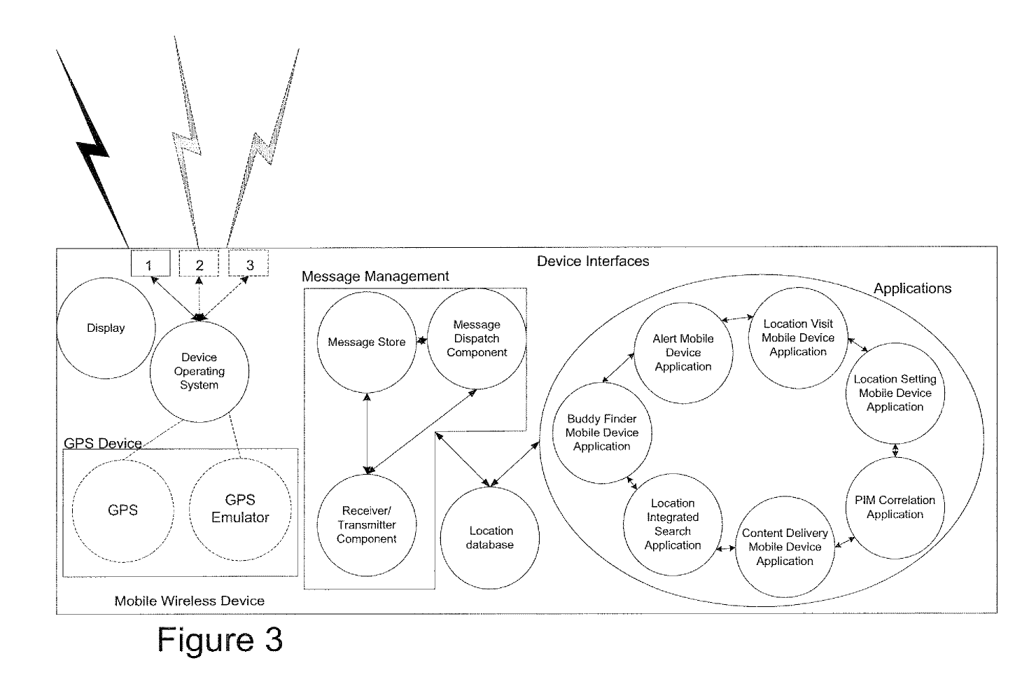

FIG. 3 illustrates a block diagram of an exemplary illustrative non-limiting mobile device. The exemplary details of the components follow below.

Exemplary Illustrative Non-Limiting Configuration Component

The configuration component (not shown) provides the mobile device a persistent store of configuration options and the application components to manage these options. The exemplary illustrative non-limiting configuration component supports the following options:
At least one mobile device ID(s)
At least one mobile service credential(s)
At least one transceiver specification(s)
At least one mobile application specification(s)
Configuration option: Mobile location awareness
Configuration option: Enable/disable software update
Configuration option: Software update mode (Manual/Automatic)
Configuration option: Software update check frequency (Daily/Weekly/Monthly)
Configuration option: Store suspended message (YIN)
Configuration option: Timed location interval (in minutes)
Configuration option: Message transmit protocol (SMS. TCP/IP, . . . )
Other
   Exemplary Illustrative Non-Limiting Display Component

The exemplary illustrative non-limiting display component displays messages on the mobile device's screen. It interfaces with the mobile device operating system's device driver for the mobile device's video screen.

Exemplary Illustrative Non-Limiting Message Management Component

The exemplary illustrative non-limiting message management component comprises a message dispatch component, an optional message store, and a receiver/transmitter component. These components cooperatively process messages sent to and from a mobile device.

Exemplary Illustrative Non-Limiting Message Dispatch Component

The exemplary illustrative non-limiting message dispatch component manages the sending and receiving of messages between application servers, the mobile device's device drivers, and the mobile device application components. The message dispatch component parses a message, determines required destination and transmission protocol and queues the message for the receiver/transmitter component, the message store, or for one or more mobile device applications. The message “service code” is used by the message dispatch component to assist in the dispatching process.

The message dispatch component is configured to respond to administrative requests, such as those administrative messages generated by the server-side message engine. These messages include providing message receipt notifications, message display notifications, and debugging messages.

The message dispatch component may be configured to generate one or more messages based upon external events such as a change in state of a transceiver, the change in state of a GPS device, a change in mobile device location, the running of an application on the mobile device, or the receipt of a specific message type or specific message content by the mobile device.

Exemplary Illustrative Non-Limiting Message Store

The exemplary illustrative non-limiting message store is an optional component that stores messages that have been received but not processed. In some cases, messages stored in the message store may be location or time specific messages that have not been processed because the mobile device is not within the specific location or time defined by the message. Messages that are stored within a message store for this reason are called “suspended” messages.

The message store periodically searches all “suspended” messages and discards those that have “timed out.” The message store determines a message has timed out by comparing the current timestamp to the timestamps in the message body. Messages that arc timed out are discarded without additional processing.

The message store also provides a “search” interface that may be used by other components to locate suspended messages that match specific criteria.

Alternatively, the message store may be used as a send/receive queue by the receiver/transmitter component during periods of operation when a message may not be sent or processed by the mobile device. These periods of wireless network inaccessibility are prevalent in mobile device operations.

Exemplary Illustrative Non-Limiting Receiver-Transmitter Component

The exemplary illustrative non-limiting receiver/transmitter component provides message queuing, operating system interface, and message parsing services. The receiver/transmitter component provides the necessary translation between the “normal” form message and the transmission-formatted message. In some cases, this involves receiving a message from the message dispatch component, translating the message to a form where it may be encapsulated using an existing protocol such as TCP/IP or SMS, and then sending the message using the specified transmission protocol. In converse. The receiving portion of the receiver/transmitter component receives messages in the protocol-based format, translates them to the “normal” message format for the mobile device, and forwards the message to the message dispatch component for further processing.

Exemplary Illustrative Non-Limiting Device Update Component

The exemplary illustrative non-limiting software update component checks periodically for new software versions and either downloads the updated software or data, or optionally notifies the subscriber or other user that updated information is available. The subscriber or other user should have the option to control how updates are performed (automatically or manually). The default operation is to automatically check for and update software as required. In an automatic mode, the update check will he during off-peak hours.

If so configured, the update component periodically polls the application server to determine if the mobile device's applications or data require updating. If either of these components requires updating, the update component responds by requesting an update and then receives and processes the update.

Periodically, it may be necessary to send an emergency update to mobile devices. In this case, a special message is sent to the mobile device telling it to update the software. The update component receives this message, and if the subscriber or other user has automatic updates selected, then mobile device automatically downloads a new program to the mobile device. If the subscriber or other user does not have automatic updates selected, a message is displayed to the subscriber or other user indicating that an emergency update is available for download.

Periodically the mobile device needs an update to data resident on the mobile device. For example, databases of well-known locations may periodically change. This update can happen at the same time as the software update check, or it may happen at other times. However, this process will happen automatically regardless of the subscriber or other user's update preferences. The data download needs to take place in such a manner that if it is interrupted it will resume when the process restarts and is prioritized to minimize disruption of normal use of the mobile device.

Exemplary Illustrative Non-Limiting Location Calculation Component

The exemplary illustrative non-limiting location calculation component calculates and persistently stores the current and historical locations of the mobile device. The location calculation component preferably comprises one or more of a location calculator, a database of past and projected locations, a database of “well known” locations, and a database of “pre-calculated routes.” The use of separate database instances is illustrative—the actual deployment will depend upon the mobile device's characteristics.

Most mobile devices allow subscribers or other users to select a location awareness preference. These preferences indicate if the applications on the mobile device will have access to the subscriber or other user's location through the location subsystem. The location calculation component may monitor this setting and warn the subscriber or other user if the setting or a change in the setting interferes with a mobile device application's ability to determine where the mobile device is located. If possible, this warning will provide instructions on how to configure the mobile device to allow the mobile device application access to such information.

A mobile device's location calculator interfaces with the device driver software components of the mobile device's operating system and determines location calculation inputs. For example, the location calculator component may obtain a complete GPS position from the operating system (e.g. by requesting the location from a GPS-equipped mobile device). or alternatively, the location calculator may obtain the identification and signal strength of specific cellular transmitters that are sending signals that have been received by the mobile device, and use this information in conjunction with the database of well known locations of appropriately tagged cellular towers and signal strengths to approximate a current location based upon these values from the well known locations' database.

The mobile device's location calculator component operates on a timed and on-demand basis. When operating in timed mode. The location calculator periodically obtains the current location, either from the mobile device hardware, or by calculating the current location based upon inputs from the mobile device hardware. In on-demand operation, the mobile device's location calculator performs this operation at the request of another software component within the mobile device applications. After obtaining the mobile device's location, the mobile device location calculator optionally stores this location and an optional timestamp in the database of past locations described below.

The mobile device's location calculator component optionally may send a message to other mobile device application software, or may initiate a message from the mobile device to an application server on the basis of matching or not matching a predefined location. The location calculator component optionally may provide additional context to the message store search in the form of additional information as to whether the mobile device is entering or leaving a location being watched.

Alternatively, if the mobile device's location has changed by more than a specified amount, the location calculator component calls the message store to search for suspended messages that the mobile device should now process. These messages are removed from the message store and processed by the message dispatch component as they are located.

Exemplary Illustrative Non-Limiting Trip Templates

Exemplary illustrative non-limiting trip templates are a trip abstraction that may be calculated either at a server or at a mobile device, and then used by the mobile device for location prediction. A trip template comprises a set of well known locations, preferably ordered by the amount of time required to transit between them. Each location associated with a trip template has a unique tag that identifies the location as being part of a specific trip template.

A trip template may be calculated based upon past location information stored by the device (as subsequently associated by adding a trip template tag to each location in the template), it may be recorded “on the fly” by the mobile device (as described below using the location setting mobile device application), computed on a prospective level based upon known trip endpoints and an assumed travel route, or calculated based patterns deduced from a set of location points collected by at least one mobile device.

Location records, when stored in a database, may have an optional timestamp associated with them. This timestamp may be used to secondarily order location records associated with a specific trip template tag, and provide a set of “checkpoints” along the travel route. A checkpoint is preferably a fixed location, such as an intersection or turnoff Timestamps associated with trip template location records are preferably 0-based, so the estimated time of travel may be easily determined by comparing the timestamp values. Alternatively, the mobile device software can compute the difference in time in the timestamps associated with various location records to determine the estimated travel time.

Trip templates may be produced on the device as described elsewhere in this document, or they may be alternatively created using data analysis techniques or external sources. In a first case, a set of location records are analyzed, either by the mobile device, by an external server, or cooperatively by the mobile device and at least one external server. The analysis uses well understood regression analysis techniques to determine similar trips based upon the location records, and then to determine common trips that can be aggregated.

An example of this type of analysis is the analysis of a morning commute. A subscriber or other user generally leaves their home (a first fixed endpoint) at approximately the same time each morning, and subject to traffic delays, reaches work (a second fixed endpoint) at about the same time each morning. Generally, the travel route is the same, or is subject to at most a few variations. Analysis of trip location records from several trips will identify that a trip between the first endpoint and the second endpoint occurred at roughly the same time each day, and took the calculated routes. During the analysis process, some location records may be added or omitted to the final trip template. Each common route can be converted to a separate trip template between a first endpoint and a second endpoint and the timestamps associated with each location record associated with the trip template normalized. The average time for each trip also can be computed, and an average trip time by route can be calculated.

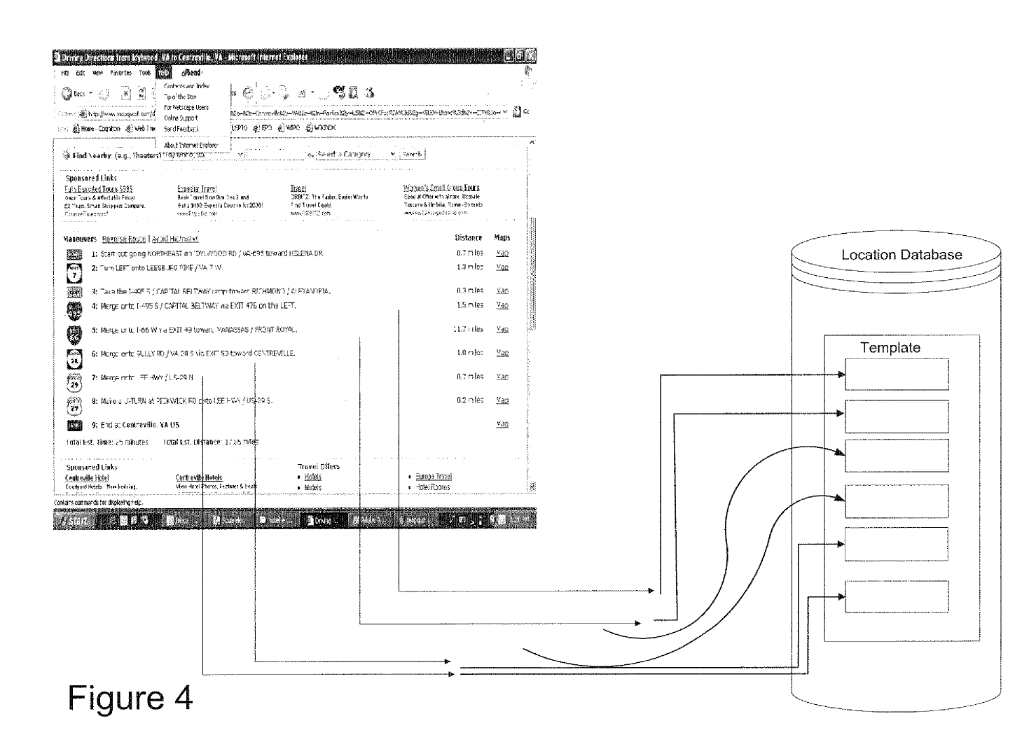

In a further example, illustrated in FIG. 4, the trip templates may be automatically correlated with the output of an external service, for example, a set of driving directions, and driving directions for the trip template automatically calculated. Once correlated with, an average drive distance between location records may be further associated with each location record. Similarly, a trip template may be created from a set of driving directions, such as those received from a service such as.

Trip templates may have counters associated with them, as described below for location counting.

Trip templates may also be automatically updated based upon real-world conditions. For example, the drive between Beltsville. MD and Reston. VA varies based upon the day of the week and time of day, as well as additional information such as traffic accidents and road closures. The driving directions indicate that this trip takes 38 minutes. Actual trip times vary from 38 minutes to two hours, depending upon external factors such the time of day, accidents, etc. Using the above described analysis tools, the trip times can be correlated to hour of travel, and an updated trip template produced. The updated trip template may have historical average travel times in place of estimated times, or may use other algorithms to more accurately estimate time between location records. Similarly, if road construction delays traffic regularly along a stretch of road, the travel time along that stretch of road will increase until the road construction is completed. The trip template can be constructed so it uses a moving average of recent trips (e.g., the most recent five trips) to calculate the estimated trip time in lieu of using fixed trip time estimates. FIG. 4 illustrates an example process for converting a set of location records to a trip template.

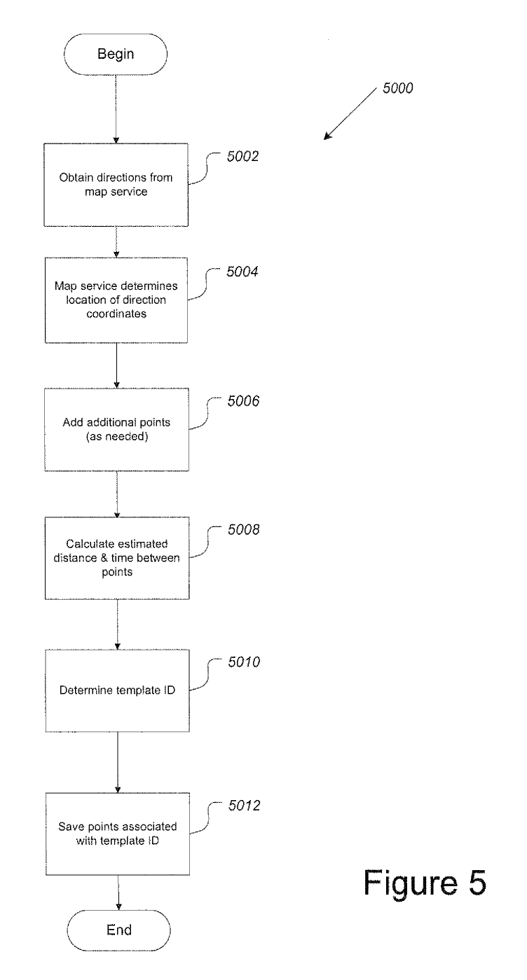

FIG. 5 illustrates an exemplary process (5000) for creating a trip template from a set of driving directions. A user obtains a sequence of directions between the desired origin and destination (5002). The mapping service determines the “location of direction” coordinates (5004), obtains any additional points (5006), and calculates and estimated distance and travel time between the points (5008). Next, a template as described above is identified as a template ID (5010) and the points are associated with the template ID (5012).

Exemplary Illustrative Non-Limiting Location Prediction

The exemplary illustrative non-limiting location prediction algorithms provide a basis for predicting where a mobile device may be based at a future (or past) point in time.

A simple location prediction scheme correlates the contents of a subscriber or other user's PIM calendar entries with well-known locations. If a subscriber or other user is scheduled for a meeting at the “Reston Office,” it is generally a safe assumption that the mobile device will be at the Reston Office at the meeting time. Location readings taken during the meeting may be associated with “Reston Office” location if a “Reston Office” location has not been previously identified.

Similarly, location prediction may be performed upon the basis of a well known route. In simplest form, driving directions, such as those produced by a service like MapQuest, may be used for location prediction. If the current location and destination are well known, the software may compute a series of checkpoints and drive times corresponding to turns identified by the MapQuest directions. The MapQuest projected drive times may be adjusted based upon actual travel conditions.

In addition, the subscriber or other user may use one or more mobile device applications to obtain a time ordered set of locations. Alternatively, a subscriber or other user may obtain a trip template for a specific trip, either by creating their own trip template, or by downloading one from a server. The time ordered set of locations may be correlated with a known set of checkpoints, such as those generated by MapQuest (as described above). If a set of checkpoints is not available and the endpoints of the trip are associated with a street address, a set of checkpoints may be obtained automatically from a service such as MapQuest. The predicted location and duration of trip may be obtained by projecting the current location along the time ordered set of locations (or trip template), and extrapolating an estimated arrival time at each location. The extrapolation process may be made more accurate by incorporating real-time traffic delay and slowdown information.

Alternatively, if multiple trips start and end at the same endpoint and a sequence of time-based locations are available, a percent completion score may be calculated for each point and the resulting data set curve fit to known travel routes between the endpoints. This allows back fitting of actual data to known travel routes, In addition, average travel times may be calculated and stored for future use.

When a subscriber or other user starts out without specifying a destination location, past trip information can be used to pre-calculate a set of possible destinations based upon previous travel patterns. For example, if a subscriber or other user is driving from College Park. MD to Reston, Va., and has not specified a destination, the location predication software notes that previous trips have gone from College Park to Rockville. MD, from College Park to Bethesda. MD, from College Park to Fairfax, and from College Park to Reston. Analysis of projected routes identifies common travel on the Capital Beltway through exit 23, where they diverge. The trip to Bethesda departs the beltway at this location. The trip to Rockville diverges at exit 25, and Reston and Fairfax diverge at the Dulles Toll Road.

Other heuristics may be used to further select the destination, such as calendar entries in the mobile device's PIM, or the time of the trip. Alternately, the mobile device may select pre-planned or well known trip templates from list of trip templates stored within the mobile device's database. For example, if the subscriber or other user has a scheduled meeting at the Reston office in an hour, it is more likely that the predicted trip will terminate in Reston. Similarly, if the trip is occurring during normal drive time to/from work, it is likely that the trip will terminate at the location the commute normally terminates (e.g. the local watering hole, or at home).

The mobile device can monitor its current location and use that information to update the predicted trips to each known location. When the device has moved from the path of the known trip, its prediction analysis is stopped and prediction is m continued solely on the remaining plausible trips. The predicted trips can be used by various mobile applications such the alert mobile device application.

If the prediction algorithm reduces the number of trips to a plausible number, it may ask the subscriber or other user which of the predicted trips they are taking. The subscriber or other user may select from one of the choices to further reduce the number of predicted trips that are being simultaneously calculated.

Location prediction may be performed on the mobile device, at a remote applications server, or at a combination of the locations. Additionally, location prediction algorithms may use any information stored in the location database, or in other databases accessible to the device (mobile device or server) that is producing the location prediction.

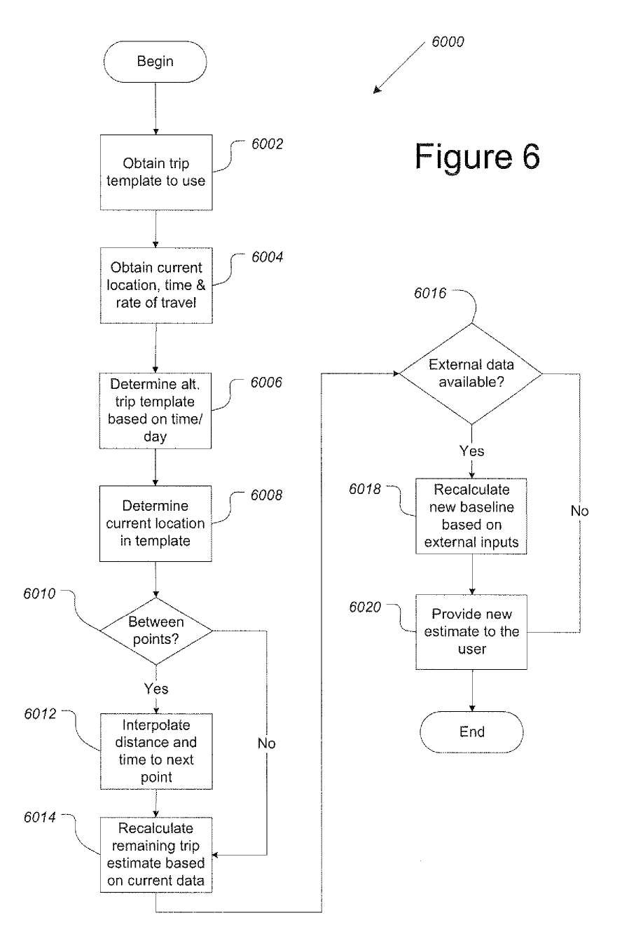

FIG. 6 illustrates an exemplary illustrative non-limiting process (6000) for computing a projected time at locations based upon current location, a current time, and a trip template, and adjusting these calculations based upon external information. There, a trip template is obtained (6002) along with the current location, time, and rate of travel (6004). An alternate template is determined using time and day information (6006), and the current location of the device of the exemplary illustrative non-limiting implementation in the template is determined (6008). If the current location of the device is between points (6010), then the distance and time to the next point is interpolated (6012) and the remaining trip information is recalculated using the interpolated data (6014); otherwise, the remaining trip information is recalculated directly (6014). If external data is also available (6016), then a new baseline is recalculated using the external data (6018) and a new estimate is provided (6020); otherwise, the new estimate is provided directly (6020).

Exemplary Illustrative Non-Limiting Location Database

A mobile device may maintain one or more databases of locations of interest. Each entry in the database is called an element. In some cases, portions of this database are pre-populated, in others, portions of the database are populated as needed, and in still other instances, portions of the database are populated with subscriber or other user specific information.

The location database on a mobile device may be stored as a single database, or may be stored as a set of disparate databases associated with one or more specific mobile device applications. The storage of the elements within a single database or within disparate databases is an implementation decision and may be made for performance or information separation purposes.

The mobile device database in one exemplary illustrative non-limiting implementation is composed of base information and associated application-specific tags and links to other application information. Tags may be used to associate specific information with an element in a database. For example, a tag may be used to associate a specific location with a database element. Links may reference other elements within the database, or alternatively may link to applications (both mobile and external) and data outside the mobile device.

A mobile device preferably maintains a set of past locations it has previously been located at as elements in the location database. Each “previous location” element may be associated with an optional timestamp, an optional error factor, and an optional set of application tags. The timestamp may be used to determine when the mobile device was present at the location. The error factor may capture the error factor present in the recorded location, and the application tag(s) may be associated with the location by one or more of the mobile device application components described below.

A mobile device preferably maintains, within the database, a set of “well known” locations. The mobile device's applications and the mobile device's location calculation algorithms may use these locations. In some cases, these “well known” locations may be associated with specific locations, such as a subscriber or other user's home or work location, or other places of personal or business importance. Each well-known location may be associated with an optional timestamp, and optional error factor, and one of an optional series of application tags. The timestamp may be used to determine when the mobile device was present at the location. The error factor may capture the error factor present in the recorded location, and the application tag(s) may be associated with the location by one or more of the mobile device application components described below.

In one usage, the database of “well known” locations may contain the locations and identifications of cellular transmitter antenna. These locations would be tagged with the broadcast identity of the cellular transmitter+antenna identification value obtainable over-the-air. In an additional usage, the database may contain location entries for each discretely identifiable location in the coverage area, and may identify the location, and as tagged values associated with that location, the ID of each visible cellular transmitter, and its estimated signal strength.

In an alternate usage for storage of well-known locations, the database may contain the locations, ID strings, and pass-phrases of well-known WiFi “hot spots,” and may further contain the location of well-known business establishments, such as all of the Starbucks in a relevant geographic area.

Each element in the database may be tagged with a period of relevancy, after which it optionally may be processed or removed from the database. Database elements that are outside their period of relevancy are considered “expired”. This feature permits the database to collect information “on the fly” and to automatically remove that information when it is no longer needed.

One tag associated with a “well known” location may be a counter used to count the number of times that the mobile device has been present at that location, or a counter of the number of times that the location has been used in a location calculation. These counters permit the automatic “garbage collection” of unused locations over time.

The “well known” location database may further contain locations that the mobile device has “visited,” along with any tags associated with these locations. These locations may include locations records by mobile device application components as described below.

In addition, the “well known” location database may contain additional information, such as the locations of public landmarks, personally relevant locations, or well-known stores. For example, the database may contain a list of all Starbucks, along with information about their hours, telephone number, or WiFi “hot spot” details. Other information, such as driving instructions, or drive distances may be associated with specific location records. In some cases, personally relevant locations will be included in the database. For example, “Home” and “Work” entries may be stored in the database.

The location database also may contain mobile application specific information, such as pending alerts used by the alert application described below. In this case, the alert information is stored as elements in the location database and each element is associated with the alert application in addition to having other tags associated with it.

On a periodic basis, the location database may be scanned and elements that are expired or no longer useful may be removed from the database. This process is called garbage collection. Garbage collection may be performed on a periodic basis, on a space-required basis, or upon the occurrence of mobile application specific events. The garbage collection algorithms may use tags associated with database elements to determine if the element has expired, is still relevant, has been accessed recently (or at all), or is marked for deletion. Garbage collection may be performed for the whole database, or for portions of the database associated with a specific mobile application. After an element has been identified for removal from the mobile device by the garbage collection algorithm, the element is deleted from the mobile device database. Alternatively, the element may be copied to a server or other system for archival storage purposes.

It is not always possible for the location database handler to determine if an element should be removed based upon its tag values. If an element is associated with a mobile application, the location database handler may call the mobile application to assist with determining if the element is still relevant.

Exemplary Illustrative Non-Limiting Mobile Device Application Components

In exemplary illustrative non-limitations, there is at least one application that operates on the mobile device.

Each mobile device application component is associated with one or more service codes for which it should receive messages. Messages received with one of the defined service codes will be dispatched to the associated mobile application by the message dispatch component.

A mobile device application may download additional information into one or more of the mobile device databases, and may additionally add, remove, or change tags associated with one or more locations. In this manner, mobile applications may customize their operating environment by creating new associations between locations and mobile applications.

Specifically, a mobile device application may collect subscriber or other user demographics and maintain them in a database. Other mobile device applications may then use this demographic data in determining the manner in which to display certain messages.

Exemplary Illustrative Non-Limiting Alert Mobile Device Application

An example of a mobile device application is the “alert” application described above that displays the contents of a message if the mobile device is within the specified location area. The location search also may match based upon the presence, absence, or values associated with one or more tags associated with specific location values.

Thus, an alert message may describe multiple alert delivery areas. Alert delivery areas may be defined as map coordinates. Preferably, they are defined in the form of polygon descriptions, where the polygon is defined as a set of location coordinates. The list of alert delivery areas may be used in several ways.

In a first example, a list of alert delivery areas defines the complete area referenced by the alert. The presence of the device within any of the defined alert delivery areas indicates that the alert message should be delivered. Alternatively, each alert delivery area in the list may be associated with a different message text. In an alternate example, multiple alert delivery areas may be defined, a first delivery area designating a critical delivery area, and a second, larger alert delivery area for the overall alert area.

In a first implementation in which messages are ordered based upon relative importance, the search may be optimized by stopping the search after the first match. For example, if a series of alert delivery area locations is provided, the first location in the series of alert delivery areas that matches the device location terminates the matching process. The alert application displays the message associated with the matched location. In alternative implementations, the search continues looking for a “best fit” of the messages provided, where “best fit” is algorithmically determined by the searching program and may be selected using any of the message attributes or content.

In the alternate example above, where a critical delivery area and an alert delivery area are defined, if the mobile device location matches the critical delivery area, the search is stopped and no match is attempted against the alert area. The message for the critical delivery area then is delivered.

In a second mode of operation, the alert mobile device application may compare the location(s) and valid times specified in the message with the historical location(s) of the mobile device over the valid timeframe for the message. If the locations and times match, the alert application displays the selected message.

In another mode of operation, the alert mobile device application additionally may take a vector of locations and times, and compute a predicted location for the mobile device over the life of the vector. The vector may be treated as a set of location points, or may directed node grid based upon an underlying map structure. Alternatively, the vector may be a trip template as described elsewhere in this document. Based upon the predicted location of the mobile device, the alert mobile device application may compare the locations and valid times provided in a message against the locations and times predicted for the mobile device from the vector. If the locations and times match, the alert application displays the selected message.

Specific message types may be associated with specific notification tones, so the delivery of a traffic alert message may play a subscriber or other user-specified tone as the notification tone. This feature may be enabled or disabled by the subscriber or other user. Alternatively, the subscriber or other user may specify that any message type ring silently.

The alert mobile device application may be used to deliver advertising content to subscribers or other users based upon their current, past, or predicted location(s).

Exemplary Illustrative Non-Limiting Location Visit Mobile Device Application

The location visit mobile device application assists with determining when a mobile device is present at a well-known location. In simplest form, the application increments a counter associated with a specific location in the location database. This application may be used to count the number of times or length of time a mobile device has been present at a specific location. The location visit counting process is started by the receipt of a message requesting that a visit to a specified location be recorded in the location database.

Alternatively, the location visit may record presence duration at a location, and may be used to associate the current device location with well-known locations. These locations may be defined in the location database by any mobile application. Alternatively, the locations may be defined as one or more static locations, such as a specific Starbucks coffee shop.

Exemplary Illustrative Non-Limiting Location Setting Mobile Device Application

The location setting mobile device application provides the subscriber or other user a way to collect location coordinates using their mobile device. In this example, the subscriber or other user has a mobile telephone type of mobile device running the location setting mobile device application. When activated, the subscriber or other user may move around and collect new location settings. In one example, a location position is registered each time the subscriber or other user presses a button on their mobile device. Each button press initiates an on-demand location reading and stores the location into the location database with an application specific tag. The subscriber or other user is permitted to set the value of the tag to a subscriber or other user-meaningful value (e.g., drive home), and associate the set of locations with this tag, and alternatively, tags of other predefined sets of locations. Alternatively, the subscriber or other user may select the automatic record mode, start the recording process by pressing a button, and the location setting mobile device application will record the mobile device's location on a periodic basis. The periodicity of the location recording function is an option to the application. This feature permits the subscriber or other user to concentrate on other activities (such as driving) while the mobile device records the subscriber or other user's location.

After recording a location (or set of locations), the subscriber or other user may associate the location(s) with a specific location (e.g. home, work), an activity (e.g. drive home from work), or location (e.g. boundaries of the territory), and record these associations using tags within the database. Similarly, the locations may be associated as a trip template for later reuse, for example, in location prediction algorithms.

The information collected from the location setting mobile device application may be used to establish subscriber or other user demographics. In a first case, the location of the mobile device between the hours of 11:00 p.m. and 5:00 a.m. may be averaged, and the averaged location may be considered a “home” location. Similarly, the location of the device between 10:00-11:30 a.m., and 1:30-3:30 p.m. may be averaged, and the average location considered a “work” location. These locations may be tagged appropriately in the location database.

In addition, the mobile device may note patterns of movement associated with the mobile device. In particular, the mobile device may note the moving location of the mobile device most of the time between 5:00 p.m. and 6:30 p.m., and assign the vector representing these locations as the evening commute.

Alternatively, the location setting mobile device application may identify locations where a mobile device is taken regularly by utilizing the location counting mechanism described herein, and pop up a request for the subscriber or other user to identify the location. This mechanism permits the subscriber or other user to identify frequented locations for later use. In simplest form, this permits the subscriber or other user to confirm the applications guess as to home and work locations, but may be alternatively used to identify drive routes and other frequented locales.

Additionally, the location setting mobile device application permits the subscriber or other user to edit or delete any of their personalized location information and to view the information that is being retained about them.

Exemplary Illustrative Non-Limiting Correlation Application

Many mobile devices have built-in to-do and calendar lists. The mobile application may associate a set of locations with one or more to-do items, and notify the subscriber or other user whenever they come near one of the locations associated with a to-do entry. For example, if the to-do entry is to stop at Home Depot and pick up some paint, the mobile device can locate all Home Depot's in the location database based upon a unique Home Depot tag, and then alert the subscriber or other user whenever they drive buy a Home Depot store to remind the subscriber or other user to stop and get their paint.

Alternatively, the to-do list correlation application may alert whenever the subscriber or other user passes any place that stocks paint. In this case, the application would alert whenever the subscriber or other user passes a Home Depot or a Lowes.

Similarly, the mobile application may correlate locations specified in calendar entries with specific entries in the location database, and use this information to provide useful location dependant information to the subscriber or other user. For example, the mobile device may provide traffic alerts to the subscriber or other user during normal working hours if their calendar indicates that they will be out of the office, but not while they are expecting to be in the office. Alternatively, the PIM correlation application may identify an out-of-office location in a calendar entry and automatically obtain a MapQuest entry for the location represented by the calendar entry. In addition, the mobile application may obtain driving directions from the current location to the location represented by the calendar entry. Based upon these driving directions, a projection of subscriber or other user location may be calculated, and a “leave by” time calculated.

Similarly, the PIM correlation application may correlate calendar entries with the location of the mobile device. Thus, if a calendar entry indicates that a meeting will occur at a physical location (such as a well known restaurant), the PIM correlation application can capture the mobile device location before, during, and after the meeting, and determine the location of the meeting and associate that location with a tag corresponding to the identified location. In this way, a calendar entry to meet Bob at “Bob's House” can be correlated with the tag “Bob's House” based upon where the meeting took place.

Additionally, the PIM correlation application may generate alerts to the subscriber or other user based upon notifications and alerts combined with calendar entries and the current location. In a first instance, if the subscriber or other user is projected to travel from College Park, Md. to Reston, Va. for a 2:00 p.m. meeting, and the trip takes 40 minutes based upon the MapQuest information, a first PIM alert can be scheduled at least 40 minutes in advance of the meeting to alert the subscriber or other user that they must leave for their meeting.

Additionally, if alert information is received indicating a traffic accident on the Cabin John Bridge, the projected drive time can be modified and a new, earlier alert scheduled so the subscriber or other user can be alerted in time for them to arrive at the meeting on time in spite of the traffic problems. Alternatively, the subscriber or other user can be alerted to alternate driving routes that will reduce their drive time.

Finally, the PIM correlation application may control the ring tones used by a mobile device. If the PIM indicates that the subscriber or other user is in a meeting, and the subscriber or other user has selected an option to silence their mobile device during meetings, the PIM correlation application may change some or all of the ring response of the mobile device. In this way, the subscriber or other user may define specific callers, message types, or content types that may “ring through” to their mobile device, and all others will either be postponed, displayed as a visual alert, or have their ring mapped to a non-audible alert (such as a vibrate).

Exemplary Illustrative Non-Limiting Content Delivery Mobile Device Application

The content delivery mobile device application provides for the delivery of content to a mobile device, and the subsequent “playing” of that content either at the time of delivery or at a later time. Content may be delivered over the same communications interface as the original message was received, or the content may be delivered using an alternate communications interface. Specifically, a mobile device may receive a message over its Bluetooth interface directing the subscriber or other user to download a video advertisement over a convenient WiFi network. The content delivery application would receive the initiating message when the subscriber or other user was standing in front of a store display and then follow the reference to the video advertisement using a high speed WiFi network.

The content delivery application may specify a set of content delivery areas, and may associate specific content with each content delivery area. When determining if a specific location is within a list of content delivery areas and then selecting the content to deliver, the search is stopped upon the first match. If a series of content delivery area locations is provided, the first location in the series of content delivery areas that matches the device location terminates the matching process. The content application displays the content associated with the matched location.

The content delivery application may use the “callback” number to link the subscriber or other user to a web page, hot line, or other source of additional information. On mobile devices equipped with “direct connect” capabilities, the content delivery may map a direct connect key to a specific “live help” person.

Note that specific content may be associated with specific notification tones, so the delivery of a McDonalds coupon may play the McDonalds jingle as the notification tone. The notification tone may be specified by the content provider, and may be delivered in the same message or in an earlier message. This feature may be enabled or disabled by the subscriber or other user.

Exemplary Illustrative Non-Limiting Buddy Finder Mobile Device Application

The buddy finder mobile device application provides a capability to identify other nearby mobile devices that share location/attribute/configuration details, and to alert when such a mobile device is located. The buddy finder application may be configured to alert for different levels of sensitivity (e.g., alert if I am in the same room with an Anime fan, or alert if I'm in the same city as an old college roommate).

Alternatively, the buddy finder mobile device application may be configured to provide contact data (to include a direct phone number), direct connect/push-to-talk information, or other connection information in order to facilitate connection with the mobile “buddy”. This feature would be used by the subscribers or other users of newly located mobile devices to connect to their “buddy.”

Exemplary Illustrative Non-Limiting Location Integrated Search Application

The location integrated search application integrates the mobile device's location with a third party search request and orders the results with respect to the mobile device's (or another) location.

In a first instance, the location-integrated search uses the mobile devices' current location and returns search results ordered with respect to the mobile devices' current location. Thus, a search for Starbucks' locations will answer location questions (such your zip code) and return results relevant to the mobile device's location.

In a second instance, the location integrated search uses a location known to the mobile device and returns search results ordered with respect to the specified location. Thus a search for a Starbuck's location will return the locations ordered around a specified location. This location is preferably associated with a well-known location in the location database, or is alternatively a location associated with a PIM entry.

Exemplary Illustrative Non-Limiting Wireless Infrastructure

The wireless infrastructure described herein is a commercial cellular, WiFi (802.11), Bluetooth, or other wireless network. Preferably, the commercial cellular is a GSMIGPRS network such as the one provided by Nextel. Alternate network systems will provide equivalent capabilities.

Because of the limitation of different networks, one implementation of the system preferably uses TCP/IP, UDP, or port-specific SMS messages to deliver messages to mobile devices. Alternatively, network provider specific message broadcast techniques such as IP multi-casting may be used.

Alternatively, for cellular network infrastructures, the cell broadcast methods incorporated into the cellular mobile device standards provide a mechanism for broadcasting messages to all cellular users. An alternate approach utilizes the wireless Ethernet networks that are being implemented by a variety of providers.

Exemplary Illustrative Non-Limiting Application Server

The application server sends messages to mobile devices. Generally, these messages are addressed using the facilities of a wireless infrastructure network provider.

The application server also comprises a transmission and receiving mechanism through which messages are sent to the mobile devices by way of the network provider's infrastructure. In normal operation, the transmission and receiving mechanism forwards the message to the network provider's service for forwarding to the mobile device. The transmission mechanism retries failed transmissions to mobile devices in order to ensure that messages are delivered in a timely and reliable manner whenever a mobile device is in reception range. In some cases, this means the transmission component retries sending the message as needed and handling exceptions in a manner that facilitates rapid delivery of messages as mobile devices move in and out of coverage.

The application server components either can be hosted at SLI's facilities in an ASP format, at the wireless infrastructure network provider's site, or at a customer's site for more security and control.

Exemplary Illustrative Non-Limiting Customer Control Panel

The customer interface is a web-based application that allows customers to maintain their accounts, define standard messages and locations, maintain customer subscribers or other users, maintain customer subscribers or other users, and send messages.

Exemplary Illustrative Non-Limiting System Administration Control Panel

The system administration control panel is a web-based application that is designed for SLI personnel to support the system. It is the main access point and includes all features of the customer control panel with the ability to access any customer's data, update system codes, maintain billing records, etc.

Exemplary Illustrative Non-Limiting Subscriber or Other User Interface

The subscriber or other user interface is a web-based application that allows subscribers or other users to enroll for message services, set preferences, and unsubscribe from message services.

Exemplary Illustrative Non-Limiting Location Prediction Service

The location prediction service takes current location and a set of projected trips and determines the predicted location of a mobile device on those trips. The location prediction service uses the algorithms described above in conjunction with external data services.

Exemplary Illustrative Non-Limiting Update Service

The application server provides a service for processing updates, both on a “push” basis, in which mobile device applications and data are pushed to subscribers or other users, and on a “pull” basis, in which mobile devices request and subsequently receive updates to mobile device applications and reference data.

Exemplary Illustrative Non-Limiting Software Update Check

The application server responds to software update check messages from mobile devices, and provides responses indicating the current software and data versions to the requesting mobile device.

Exemplary Illustrative Non-Limiting Forced Software Update

Periodically, it may be necessary for the application server to send an emergency update of mobile device applications or data to mobile devices. In this case, a special message will be sent to the mobile device telling it to update the mobile device's application(s). If the subscriber or other user has automatic updates selected, then the new mobile device applications and data are automatically downloaded from the application server into the mobile device.

Exemplary Illustrative Non-Limiting Data Updates on Mobile Device

Periodically, the mobile device needs updates to data resident on the mobile device. For example, databases of reference values may change periodically. This update often occurs at the same time as a software update check; however, it may occur separately if desired. The application server will stream the data download to the device and maintain checkpoints so the update process may be restarted if interrupted.

Exemplary Illustrative Non-Limiting Message Engine

The message engine coordinates the sending of messages to devices. It takes input from either the control panels or a feed from an existing system.

Two different systems are provided for messages to be injected into the message engine. A first method is an interactive web site where the subscriber or other user may define their area or interest.

The second method allows for messages to be “injected” into the system via a fiat file format. The system continually monitors for new messages to be injected in this manner. This method facilitates information arriving for a variety of legacy dispatch systems.

The message engine also provides a debugging interface for message traffic. The message engine provides the following features for debugging message traffic.

Exemplary Illustrative Non-Limiting Message Receipt Notification

From time to time, it may be necessary to monitor what messages are delivered to mobile devices. When message receipt notification is enabled, the mobile device returns a message status for each message delivered. This functionality may be able to be enabled and disabled from the server console. Message status may include status's from the below extensible list:
Received and stored (no errors)
Authentication error
Storage error
Unexpected message (if the mobile device receives a message outside of its defined message boundary)
   Exemplary Illustrative Non-Limiting Message Display Notification

From time to time, it may be desirable to monitor what messages are displayed on mobile devices for debugging purposes. When message display notification is enabled, the mobile device returns a message status when each message is displayed or discarded.

Message status may include status's from the below extensible list:
Displayed with time
Message expired and subscriber or other user was not in the target area
Subscriber or other user on mobile device when message received
Client Debugging Messages
Other

From time-to-time, it may be necessary to monitor the activity and errors that occur on the client application. When enabled at both the client and server, the system returns debugging messages from the mobile device. From the server side, the console controls this function by individual mobile device or by groups of mobile devices. Options include:
Only send critical error messages
Send all error messages
Send all error messages and usage data such as startup, shutdown, memory utilized, etc.
Other
   Exemplary Illustrative Non-Limiting Message Structure

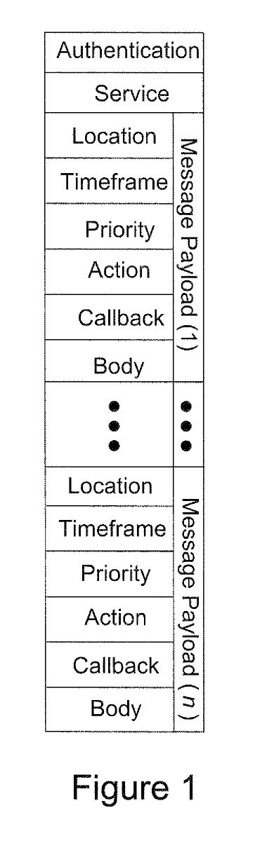

The “normal” message structure is a data structure that describes the message in platform-native form. The message format may be either fixed field, or preferably in a representation such as XML. An example of a “normal” message structure is illustrated as part of FIG. 1.

A message from the application server to the mobile device will contain at least one set of instructions for different messages to be displayed (see below).

Exemplary Illustrative Non-Limiting Authentication and Message Integrity Codes

Each message between the application server and the mobile device may contain authentication codes that may be used to determine the authenticity and integrity of the message. In one case, this may be a digest of the message itself, signed by the sender using its private key. Alternatively, other schemes that only ensure message integrity or that only ensure message authenticity may be used.

The specific authentication mechanism used may be changed on an implementation-by-implementation basis, and may be omitted in whole or in part. Authentication is provided to ensure that the application server sent messages received by the mobile device application, and that messages received by the application server were actually sent by the mobile device.

Exemplary Illustrative Non-Limiting Service Codes

The service code defines the service(s) that applies to the message. The mobile device and application server uses this code to know which mobile device application(s) should receive a copy of an incoming message.

All messages have further identifying information encoded within the service code field to support the specification of groups and sub groups within each service. Additionally, as each subscriber or other user could be a member of multiple categories, matching needs to take place to apply the subscriber or other user's subscription criteria against the message to determine if it is within the groups enabled for reception. For example, the following service and group specifications provide segregation of messages by service and group:
Service=1, Application=Public Alerting
Group=1, Severe Weather Only
Group=2, Severe Traffic
Group=3, Routine Traffic
Service=2, Application=Public Safety Agency
Group=1, Fire and Rescue
Group=2, Police
Group=3, Health and Human Services
Group=4, All County Employees
ServiceApplication=Starbucks Program
Group=1, Opt-in Mid-Day Discounts, Coffee
Group 2, Opt in, Morning Drive Time, Food Specials
   Exemplary Illustrative Non-Limiting Message Payload

Each message payload comprises one or more attributes from the non limiting set of attributes listed below:
Location
Timeframe
Priority
Action
Callback
   Exemplary Illustrative Non-Limiting Message Body

Additional attributes may be added as necessary to facilitate processing of each message payload. Sets of related message attributes are called a message. Multiple messages may be stored in a single message payload. Thus, a first message within a message payload might comprise a first location, a first timeframe, a first priority, and a first message body, and a second message might comprise a second location, a second timeframe, a second priority, a callback, and a second message body. It is not required that all messages in a message payload have the same sets of attributes. Similarly, a message may have more than one attribute of a particular type associated with it. For example, a message may have multiple locations associated with it.

It is preferable that messages are ordered in increasing granularity of desired delivery. Thus, a message that defines a small area for a critical alert, and defines a larger area for a warning message, is preferably defined with the smaller area specified first.

The most critical message is preferably ordered first in the message payload. In this model, messages listed first in the message payload have priority over messages that follow. If the mobile device application determines that it meets the criteria to display a particular message from the message payload, then all following messages in the payload are ignored by that application. If the mobile device is not in a position to display a specific message, it is loaded into the message store until it is played or until the validity parameters of the message expires.

Alternatively, messages may be ordered within the message payload on the basis of time, location, or other attribute. Ordering messages in this manner may improve searching performance by allowing searching of a message payload to stop when the first relevant match is located.

Exemplary Illustrative Non-Limiting Location

This optional attribute is the location where the message is valid. A location can be the actual location denoted by geographic coordinates, a target location, or a tag of a target location.

Target locations also may reference previously stored locations tied into a database. These previously stored locations may be tagged with a specific target location tag that is referenced by the location attribute. For example, a listing of all major intersections and roadways could be defined for message transmission and referenced by a two-byte location ID. The application would then take that information and look up the location in the database to determine the valid coordinates.

In addition to the location where the message is valid, the application also may send a density indicator for cell sites. This is the average coverage radius of a cell in the targeted geographic area.

Alternatively, the optional location field may contain a list of locations as described above. The message location is considered to be the union of the areas described by the list of locations.

Exemplary Illustrative Non-Limiting Timeframe

The message may also contain a valid timeframe. This includes a starting time for the message and a stopping time when the message is no longer relevant.

Additionally, the timeframe may reference if it is based off of GMT or the local time where the mobile device is currently located. The timeframe also may include a separate timeframe for a historical time to indicate sending of a message based on where the mobile device has been. (A message can have a valid time as well as a historical time. For example, a message could be valid from 14:00 to 17:00 local time for people who were at a stadium the day before during a game.) Timeframes may also be given such as 11:00 to 13:00 Monday through Friday until Jan. 31, 2006.

Exemplary Illustrative Non-Limiting Local VS. Absolute Time

To this end, time for a message is either expressed in local time or in an absolute time (e.g., GMT). Local time will utilize the local time where the mobile device is when the message is to be displayed. For example, messages to be delivered around lunchtime would be valid from 11:00 until 13:00 local time. The same message could be described to be delivered between 16:00 and 18:00 GMT time if the message is designed only to be delivered in Washington, D.C. This enables two forms of message delivery—a national emergency should be delivered at the same time no matter where you are, but a lunch special travels with the sun.

Exemplary Illustrative Non-Limiting Recurring Time Schedule

Message times may also be specified as recurring. For example, a message may be valid between 11:00 and 13:00 local time on Monday through Friday. Someone who was not in the area to receive the message on Monday or Tuesday would receive the message if they were in the target area on Wednesday.

Exemplary Illustrative Non-Limiting Current Time

Current time messages are delivered based on where the mobile device is currently. Current time messages have only one time associated which covers the time that the messages is valid and the triggering time where the mobile device is in a the targeted message area.

Exemplary Illustrative Non-Limiting Historic Time

Historic time messages are delivered based on where the mobile device has been in the past. Historic time messages have two times associated with them, the triggering time when the mobile device was in the target message area and the time that the message is valid. For example, a pizza company may want anyone at a stadium yesterday between 13:00 and 14:00 (the triggering time) to receive a message today between 15:00 and 17:00 (the timeframe when the message is valid). This is done for several reasons:

A coupon for a free pizza may be valid only on a certain day and we do not want the subscriber or other user to receive messages that are not relevant if they have their mobile device turned off during the valid time.

Defining messages in this manner allows us to queue messages for delivery to a mobile device when network utilization is low.

Exemplary Illustrative Non-Limiting Message Priority

A message can have a priority of low, medium, high and critical. Mobile device action is based on the priority of the message.

Low priority messages follow the mobile device's guidelines for notification of the subscriber or other user (i.e., volume levels, silent mode, vibrate, etc.). Et will not interrupt a call to notify the subscriber or other user that a message is waiting.

Medium priority messages follow the mobile device's guidelines for notification of the subscriber or other user.

High priority messages follow the mobile device's guidelines for notification of the subscriber or other user.

Critical messages are used to notify subscribers or other users of life threatening conditions. The application will notify a subscriber or other user of a message by any means possible. While a critical message will not disconnect a call, a tone should be played if possible to alert the subscriber or other user of a critical message. This mode should attempt to override current mobile device settings and take advantage of any notification means possible including setting the volume to its loudest level, vibrate the mobile device if available, flash lights and turn on the display if the mobile device is open.

Exemplary Illustrative Non-Limiting Programmatic Action

A programmatic action is a code that indicates a specific action to be taken by the mobile device with the display of a message. This may be the playing of a special tone (e.g., a branded tone that indicates an Amber Alert, Starbucks coupon, launching of an application, etc.). This is likely a code that is database driven. Additional actions may include display of a web page, a graphical image, or other non-text instructions.

Exemplary Illustrative Non-Limiting Message Body

The message body to be displayed. There may be multiple message bodies delivered with each message.

The message body can be a text block for a text message; a pointer to a database of canned messages; a pointer to an external source such as a LIRL of a media clip; a WAP page; or a multi-media blob that can contain pictures, video clips, sounds, music files, ring-tones, or multi-media content.

Exemplary Illustrative Non-Limiting Callback Number

Provides at least one callback number that is dialed if the subscriber or other user presses the key associated with that action. This field may alternatively include direct connect instructions for push-to-talk connection (for example, to a staffed help line), and may further contain other connection instructions. These connection instructions may include network connection instructions, text messaging addresses, passwords, connection strings, or other materials that may be used by the mobile device or network to facilitate a connection.

Exemplary Illustrative Non-Limiting Methods Of Communication

Exemplary illustrative non-limiting implementations provide methods for receiving and processing messages transmitted to a telecommunications device. In some exemplary illustrative non-limiting implementations, the methods comprise providing a telecommunications device that includes: a signal receiver configured to receive a transmitted message including message content; a device locator configured to provide an estimated geographical position of the telecommunications device coupled with the receiver; a mechanism for determining a least one historical geographical location of the device, at least one future location of the device, or both historical and future locations of the device; and a message content filter configured to determine whether at least a portion of the message content complies with at least one geographical position criterion. The method further includes receiving a transmitted message using the telecommunications device and determining the geographical location of the telecommunications device. The geographical location of the telecommunications device and at least a portion of said message content are provided to the message content filter; and at least one geographical position criterion is applied to the message content.

In still further exemplary illustrative non-limiting implementations, the method described above further includes determining a geographical position criterion based on information provided by said historical position determination mechanism. Still more specific implementations include recording past geographical locations of said telecommunications device. Yet more specific implementations include estimating at least one historical location of said telecommunications device. Still more specific exemplary implementations include determining at least one geographical position criterion based on the estimated historical location of said telecommunications device.

Other exemplary illustrative non-limiting implementations include estimating a future position of the telecommunications device. Further exemplary illustrative non-limiting implementations may include providing a geographical position criterion based on said estimated future position. Yet more specific exemplary implementations may include estimating said future position of said telecommunications device using a record of historical locations of said telecommunications device.

A further exemplary illustrative non-limiting implementation provides methods for receiving and processing content from a transmitted message selectively that comprises providing a telecommunications device including: a signal receiver configured to receive a transmitted message including message content; a device locator coupled with the receiver that is configured to provide an estimated geographical position of the telecommunications device; a message store; and a message content filter configured to determine whether at least a portion of the message content complies with at least one geographical position criterion. The method also includes receiving a transmitted message using the telecommunications device; storing at least a portion of the message content; determining the geographical location of the telecommunications device; providing the geographical location of the telecommunications device and at least a portion of the message content to the message content filter; and applying at least one geographical position display criterion to at least a portion of the message content.

Additional exemplary illustrative non-limiting implementations may comprise providing an historical position determination mechanism coupled with said message content filter. In more specific exemplary illustrative non-limiting implementations, the methods include providing a geographical position criterion based on information provided by said historical position determination mechanism; and, may further include, compiling a record of past geographical locations of the telecommunications device.

Exemplary illustrative non-limiting implementations may further comprise providing an historical position determination mechanism coupled with said message content filter include estimating at least one historical location of said telecommunications device; and still more specifically, including at least one geographical position criterion based on said estimated historical location of said telecommunications device.

In other exemplary implementations, the methods described above further comprise estimating a future position of the telecommunications device, more specifically providing a geographical position display criterion based on said estimated future position, and, still more specifically, estimating said future position of said telecommunications device using a record of historical locations of said telecommunications device.

While the technology herein has been described in connection with what is presently considered to be the most practical and preferred implementations, it is to be understood that the invention is not to be limited to the disclosed exemplary illustrative non-limiting implementations, but on the contrary, is intended to cover various modifications and equivalent arrangements included within the scope of the claims.

What is claimed is:

1. A telecommunications device for receiving and processing messages transmitted to such telecommunications device, comprising:
a signal receiver configured to receive a transmitted message, said transmitted message including message content;
a device locator coupled with said receiver, said device locator configured to provide an estimated geographical position of said telecommunications device;
a mechanism for determining a least one historical geographical location of said device, at least one future location of said device, or both; and
a message content filter configured to determine whether at least a portion of said message content complies with at least one geographical position criterion.

2. The telecommunications device of claim 1, wherein said at least one geographical position criterion includes a geographical position criterion based on information provided by said mechanism for determining at least one historical position.

3. The telecommunications device of claim 2, wherein said mechanism for determining at least one historical position is configured to provide a record of past geographical locations of said telecommunications device.

4. The telecommunications device of claim 3, wherein said at least one geographical position criterion includes a geographical position criterion based on said record of past geographical locations of said telecommunications device.

5. The telecommunications device of claim 2, wherein said mechanism for determining at least one historical position is configured to provide an estimated historical location of said telecommunications device.

6. The telecommunications device of claim 5, wherein said at least one geographical position display criterion includes a geographical position display criterion based on said estimated historical location of said telecommunications device.

7. The telecommunications device of claim 1, wherein said at least one geographical position criterion includes a geographical position criterion based on information provided by said mechanism for determining at least one future geographical location.

8. The telecommunications device of claim 7 wherein said at least one geographical position criterion includes a geographical position criterion based on said estimated future location of said telecommunications device.

9. The telecommunications device of claim 8, wherein said future position determination mechanism is configured to estimate a future location of said telecommunications device based on an historical record of geographical positions of said telecommunications device.

10. A method for receiving and processing messages transmitted to a telecommunications device, comprising:
providing a telecommunications device including:
a signal receiver configured to receive a transmitted message, said transmitted message including message content;
a device locator coupled with said receiver, said device locator configured to provide an estimated geographical position of said telecommunications device;
a mechanism for determining a least one historical geographical location of said device, at least one future location of said device, or both; and
a message content filter configured to determine whether at least a portion of said message content complies with at least one geographical position criterion receiving a transmitted message using said telecommunications device;
determining the geographical location of said telecommunications device;
providing said geographical location of said telecommunications device and at least a portion of said message content to said message content filter; and
applying said at least one geographical position criterion to said message content.

11. The method of claim 10, further comprising determining a geographical position criterion based on information provided by said historical position determination mechanism.

12. The method of claim 11, further comprising recording past geographical locations of said telecommunications device.

13. The method of claim 10, further comprising estimating at least one historical location of said telecommunications device.

14. The method of claim 13, further comprising determining at least one geographical position criterion based on said estimated historical location of said telecommunications device.

15. The method of claim 10, further comprising estimating a future position of said telecommunications device.

16. The method of claim 15, further comprising providing a geographical position criterion based on said estimated future position.

17. The method of claim 16, further comprising estimating said future position of said telecommunications device using a record of historical locations of said telecommunications device.

18. A telecommunications system, comprising:
a transmitter configured to transmit messages to a telecommunications device for receiving and processing said messages, said telecommunications device including:
a signal receiver configured to receive a transmitted message, said transmitted message including message content;
a device locator coupled with said receiver, said device locator configured to provide an estimated geographical position of said telecommunications device;
a mechanism for determining a least one historical geographical location of said device, at least one future location of said device, or both; and
a message content filter configured to determine whether at least a portion of said message content complies with at least one geographical position criterion.

19. The telecommunications system of claim 18, wherein said at least one geographical position criterion includes a geographical position criterion based on information provided by said mechanism for determining at least one historical position.

20. The telecommunications system of claim 18, wherein said at least one geographical position criterion includes a geographical position criterion based on said estimated future location of said telecommunications device.
